(19) United States
(12) Patent Application Publication
(10) Pub. No.: US 2009/0083725 A1
(43) Pub. Date: Mar. 26, 2009

(54) Firmware upgrading method for an interface card

(76) Inventor: Zhenghong Wang, Shanghai City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/081,334

(22) Filed: Apr. 15, 2008

Related U.S. Application Data
(60) Provisional application No. 60/973,884, filed on Sep. 20, 2007.

(51) Int. Cl. G06F 9/44

(52) U.S. Cl. 717/168

(57) ABSTRACT

A firmware upgrading method for an interface card is disclosed. A common interface page under a SES format is established by modifying a microcode control page thereof. More particularly, the claimed method is to upgrade the firmware of an interface driving card of a disk storage system. The preferred embodiment of the present invention includes a step of establishing a common interface page under SES format at first. Next, the step goes to interpret the control page. Next, the information in the control page is extracted. Thereby, the driving card is identified by the extracted information, and further the firmware information is extracted. After that, a processor performs to upgrade the firmware.

### REFERENCE TO RELATED APPLICATION

This Application is based on Provisional Patent Application Ser. No. 60/973,884, filed 20 Sep. 2007, currently pending.

### BACKGROUND OF INVENTION

1. Field of the Invention

The present invention relates to a firmware upgrading method for an interface card, and more particularly to upgrade the firmware under a SCSI enclosure service format.

2. Description of the Related Art

In disk storage system design, the SATA disks are often used to be a storage media for a computer system since the SATA disk has advantage of performance-price ratio. However, the SATA disk is not compatible with all computer systems. Thus a proprietary driving card such as the paddle card is employed to the SATA disk, so as to transfer the data between the peripheral devices and the communication ports. Therefore, the mentioned driving card is a requisite element for the SATA disks in consideration of compatibility. New functions could be added during the development, so that an upgrading scheme is necessary for upgrading the firmware of the driving card.

There are many ways to update the firmware in the prior arts. The firmware upgrading method, especially to the driving card of a disk storage system, includes several schemes described bellow.

The first approach performs the firmware upgrading physically, that is, the computer system connects to the storage medium which stores the upgrading via a transmission cable. For example, an I²C bus is used for driving card that needs to be upgraded connecting to the storage medium. And then the firmware program is burnt into the storage element of the driving card. This storage element can be Flash, EEPROM, and etc.

However, the first embodiment has to take the disk of the driving card outside a disk rack and connect to a burner through the I²C bus. Those inconvenient steps bring a lot of extra works, and decrease the efficiency.

The second approach performs the firmware upgrading through a communication interface. For example, a message with requirement of firmware upgrading is sent to a storage system through the communication interface. The storage system converts the data used to upgrade firmware into a corresponding data frame through the serial ATA tunneled protocol (STP) to the driving card after receiving the message.

However, because of the limitation of the transmission rate of the communication interface, the second approach still has to spend lots of time to upgrade.

### SUMMARY OF THE INVENTION

It is an object of the present invention to provide a download method for upgrading the firmware in accordance with a SCSI enclosure service. The SES download method adopts the data carried in a microcode control page written into a register to upgrade the firmware of an interface card. The mentioned microcode control page needs to be well defined. The in-band transmission used between a server and a storage system has an inherent characteristic to speed upgrading firmware, and widespread use in every environment.

One of the preferred embodiments is to provide a means for interpreting the microcode control page under the SES format to identify the firmware of an interface card that needs to be updated. Next, the firmware data for the interface card is retrieved from the microcode control page, and the data is sent to a STP initiator. After that, the data is encapsulated as a firmware program file, and then transmitted to the corresponding interface card for upgrading the firmware.

Another preferred embodiment of the present invention includes a first step of creating a common interface page of a SES download file. In which, the columns SPS ID and Buffer ID need to be filled. Next, the common interface page is interpreted and some corresponding data is read. After that, the ID for the interface card and the ID for a target equipment are identified by the data, and the firmware program with corresponding interface card is encapsulated. The encapsulated firmware program is transmitted to the target equipment for upgrading the firmware.

### BRIEF DESCRIPTION OF THE DRAWINGS

The above and further advantages of this invention may be better understood by referring to the following description, taken in conjunction with the accompanying drawings, in which:

FIG. 1 is a diagram of updating the remote firmware through the network in the prior art;

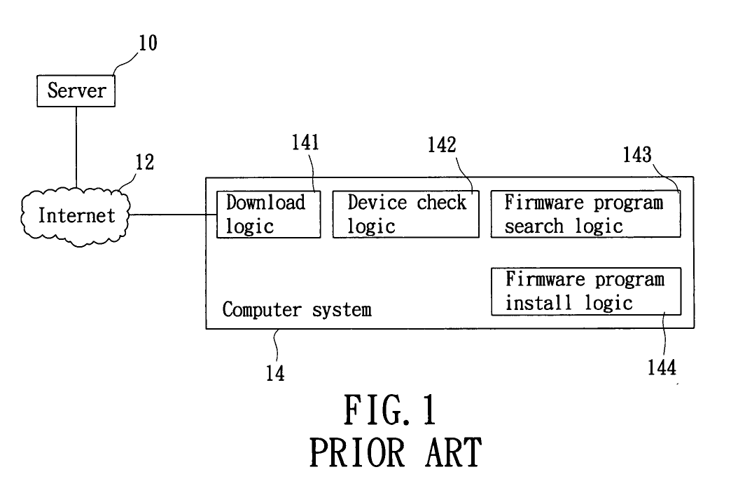

FIG. 2 is a format diagram of the microcode control page under SES in the prior art;

FIG. 3 is a system framework diagram of the firmware upgrading method for an interface card in the present invention;

FIG. 4 is a flowchart of the firmware upgrading method for an interface card in the present invention;

The drawings will be described further in connection with the following detailed description of the present invention.

### DETAILED DESCRIPTION OF THE PREFERRED EMBODIMENTS

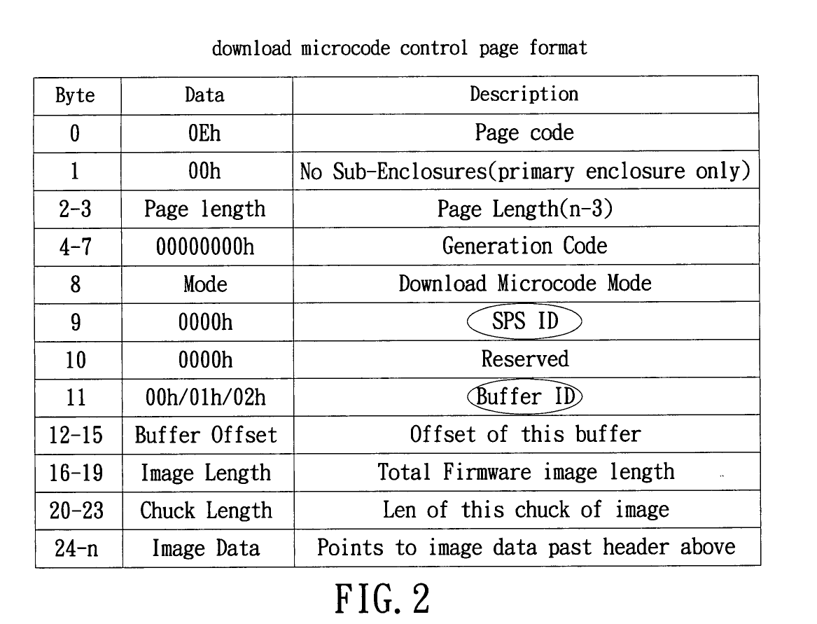

The present invention is applied to firmware upgrading, especially for upgrading the firmware of a driving card for a disk storage system. The present invention provides a download method under the SCSI enclosure service (SES) format. In the download method, the data carried in a microcode control page under the SES format is used to upgrade the firmware of the driving card. Reference is made to FIG. 2 showing a download microcode control page format. The present invention creates a common interface page of a download file according to the SES format for providing a firmware program.

For upgrading the firmware, the method of the present invention firstly defines the microcode control page under the SES format. The microcode control page under the SES format is written into a register. Since the microcode control page is a standard SES interface, and the in-band transmission between a remote server and the disk storage system has an inherent characteristics that can speed to upgrade the firmware and has widespread use for every environment.

Based on the practical requests, the page format is defined. One practical data format of the download microcode control page is shown in FIG. 2. In the data format, Byte 9 indicates a SPS ID that shows the practical number of the interface driving card. For example, in the storage system 3U15, there are 15 interface driving cards and 15 numbers, from 0 to 14. Hence, if user needs to upgrade any interface card, only the indicated number is used. The Byte 11 indicates a buffer ID that shows the practical number of target equipment. For example, in the storage system 3U15, there are 5 kinds of target equipments, and the above driving cards can be the target equipments. Hence, if user needs to upgrade the firmware of the driving card, only the indicated number corresponding to the target equipment is used.

The present invention preferably concentrates on a software design which is used to upgrade firmware, and primarily on the driving card for a disk storage system. In the preferred embodiment, based on the SES format for the microcode control page, some reserved data fields are redefined and the related information for the driving card is added. This embodiment redefines the SPS ID in Byte 9 and the Buffer ID in Byte 11 for achieving the firmware in-band upgrading.

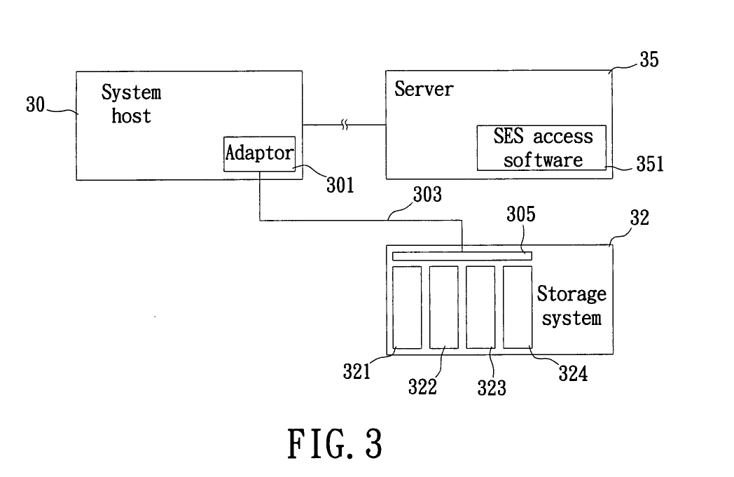

Preferably, the driving card upgrading method of the present invention employs the SES format to incorporate the firmware to be upgraded. In FIG. 3, the system framework for the storage system is shown. The system framework includes a system host 30, a storage system 32, and a server 35. The system host 30 connects to the driving card 305 of the storage system 32 through an adapter 301 and transmitting line 303, so as to access the disks 321, 322, 323 and 324 in the storage system 32. The present invention can perform well in above condition without change.

Reference is made to FIG. 3 showing the preferred embodiment of system framework. An installed SES access software 351 can be executed in the storage system 32 directly through the server 35 that connects to the system host 30. A pre-defined microcode control page is introduced to provide firmware program to the driving card for encapsulating, downloading, and upgrading. More, the server 35 having a communication interface (not shown) can provide firmware to the storage system 32 the necessary firmware program by remote access over a network. The server 35 can also use a local connection (not over network) to provide the upgrading program.

In comparison with the prior art, what the advantages the present invention provide is:
1. It is not necessary to disassemble or physically change the disk storage system of the present invention in contrast with the physical upgrading way in the conventional art, the present invention provides an easier way.
2. The closed transmission design between the remote server and the disk storage system provides a fast upgrading speed.

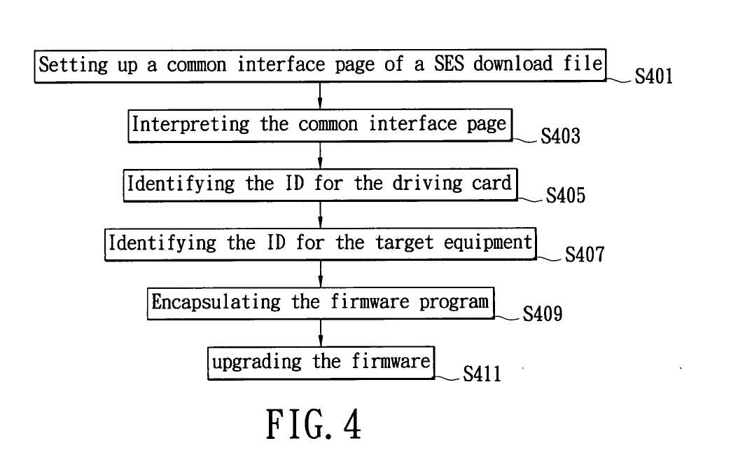

In FIG. 4, the flowchart of the firmware upgrading method of an interface card of the present invention is shown. According to interpretation of the microcode control page under the SES format, a function of microcode control page of the present invention achieves the interface card upgrading/updating of a target equipment. Firstly the firmware of the driving card is identified by identifying the number indicating the interface card. Next, the firmware information of the interface card extracted from the microcode interface control page is transmitted to an initiator of serial ATA tunneled protocol (STP). The STP will encapsulate a firmware program after receiving the firmware information. Since the program is sent to the interface card, the interface card with the corresponding number will be upgraded.

The steps of the preferred embodiment have a first step of creating a SES download file regarding to the hardware to be upgraded by modifying the microcode control page (step S401). The SES download file is produced in response to the size of the data by encapsulating the firmware program that is used to upgrade the hardware. For example, the initiator of the serial ATA tunneled protocol (STP) is to encapsulate data to the practical firmware file.

Particularly, the capsulate format accords with the format of the download microcode control page shown in FIG. 2. Especially, the SPS ID and the Buffer ID are the fields to be filled in, wherein the SPS ID is a practical number of the corresponding interface card, and the Buffer ID shows the information indicating the SPS firmware to be upgraded.

Then, the common interface page is interpreted in step S403. When the interface card receives the common interface page, the corresponding data will be extracted according to the defined format, and then being interpreted.

According to the interpretation in step S403, an ID for the interface card is determined in step S405. In the meantime, the SPS ID is extracted and the corresponding equipment to be upgraded is obtained. Next, the ID for the target equipment is determined in step S407, namely the buffer ID for the target equipment is extracted according to the defined format.

In the server, the initiator of STP encapsulates the firmware program for upgrading in response to the practical format of the interface card in the storage system (step S409) according to the mentioned ID for the interface card and the ID for the target equipment. After that, the encapsulated firmware program is transmitted to the interface card of the storage system, and a processor process the step of upgrading the interface card in step S411.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A firmware upgrading method for an interface card, wherein the interface card is a diving card of a storage system, comprising:
creating a common interface page of a download file of a microcode control page under a SCSI enclosure service (SES) format in a server;
the storage system receiving the common interface page;
identifying an ID for the interface card and an ID for a target equipment according to a SES-defined format;
the server installing with the SES access software encapsulating a firmware program according to the ID for the interface card and the ID for the target equipment; and
sending the encapsulated firmware program to the storage system and further performing the firmware upgrading for the interface card.

2. The firmware upgrading method according to claim 1, wherein the server adopts an initiator under a serial ATA tunneled protocol (STP) to encapsulate data into a firmware program file.

3. The firmware upgrading method according to claim 1, wherein the ID for the interface card is a SPS ID in the common interface page.

4. The firmware upgrading method according to claim 1, wherein the ID for the target equipment is a Buffer ID in the common interface page.

5. The firmware upgrading method according to claim 1, wherein the server provides the common interface page of the SES download file over the network.

6. The firmware upgrading method according to claim 1, wherein the server provides the common interface page of the SES download file locally.

7. A firmware upgrading method for an interface card, which performs firmware upgrading of an interface through data carried by a microcode control page under a SES format, and the firmware upgrading method comprising:
creating a common interface page of a SES download file, wherein the format of the common interface page conforms to the microcode control page;
interpreting the common interface page, in which the corresponding data is read when the interface card receives the common interface page under the SES format;
identifying an ID for an interface card in the common interface page according to the SES format;
identifying an ID for a target equipment in the common interface page according to the SES format;
encapsulating the upgrading firmware program under the SES format according to the ID for the interface card and the ID for the target equipment; and
upgrading the firmware since the encapsulated firmware program is transmitted to the interface card.

8. The firmware upgrading method according to claim 7, wherein the SES download file is produced by encapsulating the upgrading firmware program based on the real size for transmission.

9. The firmware upgrading method according to claim 8, wherein the firmware program is encapsulated by an initiator using STP.

10. The firmware upgrading method according to claim 7, wherein the ID for the interface card is a SPS ID in the common interface page.

11. The firmware upgrading method according to claim 7, wherein the ID for the target equipment is a Buffer ID in the common interface page.

12. The firmware upgrading method according to claim 7, wherein the interface card is a driving card of a storage system.

13. The firmware upgrading method according to claim 7, wherein the common interface page of the SES download file is created in a server.

14. The firmware upgrading method according to claim 13, wherein the server includes SES access software.

15. The firmware upgrading method according to claim 13, wherein the server provides the common interface page of the SES download file over the network.

16. The firmware upgrading method according to claim 13, wherein the server provides the common interface page of the SES download file locally.
